(19) United States
(12) Patent Application Publication
(10) Pub. No.: US 2016/0269232 A1
(43) Pub. Date: Sep. 15, 2016

(54) NETWORK MANAGEMENT APPARATUS AND NETWORK MANAGEMENT METHOD

(71) Applicant: FUJITSU LIMITED, Kawasaki-shi (JP)

(72) Inventor: Kenji HIKICHI, Kawasaki (JP)

(21) Appl. No.: 15/053,214

(22) Filed: Feb. 25, 2016

(30) Foreign Application Priority Data
Mar. 13, 2015 (JP) 2015-050774

(51) Int. Cl. H04L 12/24

(52) U.S. Cl. CPC H04L 41/0803; H04L 41/0893

(57) ABSTRACT

A network management apparatus including: a processor configured to: classify a plurality of communication devices in a network into a plurality of groups based on each combination of each type of packet processing performed in each of the plurality of communication devices and each type of packet processing performed in each transfer destination of each of the plurality of communication devices, set at least one virtual subnetwork so that a virtual subnetwork, which couples to at least one first communication device in a first group and at least one second communication device in a second group, is set when the at least one first communication device transfers a packet to the at least one second communication device, and transmit a control packet for communications via the virtual subnetwork, to the at least one first communication device and the at least one second communication device.

### CROSS-REFERENCE TO RELATED APPLICATION

This application is based upon and claims the benefit of priority of the prior Japanese Patent Application No. 2015-050774, filed on Mar. 13, 2015, the entire contents of which are incorporated herein by reference.

### FIELD

The embodiments discussed herein are related to a network management apparatus and a network management method.

### BACKGROUND

A technology called as Network Functions Virtualization (NFV) has attracted attention. In the NFV, functions implemented by a network device such as routers, gateways, and load balancers, are adopted as an application program, and operated as a virtual machine (VM) on a server. In addition, a virtual machine that provides the functions used in communication through the network is sometimes called a Virtual Network Function (VNF). NFV Industry Specification Group (ISG) has studied to realize the communication through broadband routers with the NFV of a standardization group of the European, European Telecommunications Standards Institute (ETSI) (for example, ETSI GS NFV 001v.1.1.1 (2013-10), “Network Functions Virtualisation (NFV); Use Cases”, [online], October 2013, European Telecommunications Standards Institute, searched on Feb. 19, 2015, Internet, <URL:http://www.etsi.org/deliver/etsi_gs/nfv/001_099/001/01.01.01_60/gs_nfv 001v010101p.pdf>). In this case, a data transfer path (service chain) that selectively uses a plurality of functions that are operated within the virtual machine on the server is used. For example, various proposals on a method by which a service chain is created according to a user's request have also been performed (for example, Zafar Ayyub Qazi et. al., “SIMPLE-fying middlebox policy Enforcement Using SDN”, [online], SIGCOMM '13 Proceedings of the ACM SIGCOMM 2013 conference on SIGCOMM, Pages 27-38, searched on Feb. 19, 2015, Internet, <URL: http://www.cs.princeton.edu/courses/archive/fall13/cos597E/papers/simple.pdf>, or the like).

### SUMMARY

According to an aspect of the invention, a network management apparatus includes a memory; and a processor coupled to the memory and configured to: classify a plurality of communication devices in a network into a plurality of groups based on each combination of each type of packet processing performed in each of the plurality of communication devices and each type of packet processing performed in each transfer destination of each of the plurality of communication devices, set at least one virtual subnetwork so that a virtual subnetwork, which couples to at least one first communication device in a first group of the plurality of groups and at least one second communication device in a second group of the plurality of groups, is set when the at least one first communication device transfers a packet to the at least one second communication device, and transmit a control packet for communications via the virtual subnetwork, to the at least one first communication device and the at least one second communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a flow chart illustrating an example of a management method according to an embodiment;

FIG. 2 is a diagram illustrating an example of a communication system;

FIG. 3 is a diagram illustrating a configuration example of a management apparatus;

FIG. 4 is a diagram illustrating a hardware configuration example of the management apparatus;

FIG. 5 is a diagram illustrating an example of a service chain;

FIG. 6 is a diagram illustrating an example of a service chain information table;

FIG. 7 is a diagram illustrating an example of a frequency table;

FIG. 8 is a diagram illustrating an example of a VNF number table;

FIG. 9 is a diagram illustrating an example of a method for generating group information;

FIG. 10 is a diagram illustrating an example of a group information table;

FIG. 11 is a diagram illustrating an example of a table illustrating a specification method example of a type of a VNF communication destination;

FIG. 12 is a diagram illustrating an example of a group correspondence table;

FIG. 13 is a diagram illustrating an example of a method for obtaining a connection relationship between groups;

FIG. 14 is a diagram illustrating an example of the service chain;

FIG. 15 is a flow chart illustrating an example of connection processing;

FIG. 16 is a diagram illustrating an example of a network obtained by the connection processing;

FIG. 17 is a diagram illustrating an example of a communication system in which a second embodiment is applied;

FIG. 18 is a diagram illustrating an example of a method for obtaining a connection relationship between groups;

FIG. 19 is a diagram illustrating an example of connection processing performed in the second embodiment;

FIG. 20 is a diagram illustrating an example of a network obtained in the second embodiment; and

FIG. 21 is a flow chart illustrating an example of the connection processing performed in the second embodiment.

### DESCRIPTION OF EMBODIMENTS

It is difficult to predict the number of virtual machines in one service chain, a type of processing that is performed in each of the virtual machines, or the like because a service chain is generated according to a user's request. Accordingly, entire virtual machines are connected (or coupled) to one subnetwork so as to enter a state to be able to communicate among the entirety of virtual machines. However, in this case, the number of available virtual machines is limited in view of a load in a case where a broadcast packet reaches the entirety of virtual machines in a subnetwork. This problem is generated even in a case where a communication device that is not the virtual machine is used in the service chain.

An object of the embodiment discussed herein is to accommodate a plurality of communication devices in the network providing a service chain.

In a method according to the embodiments, a plurality of subnetworks are adopted in connection between virtual machines, and the virtual machines in the network are classified into a plurality of groups according to a type of the virtual machine and a type of a transfer destination of a packet. A management apparatus that implements a method according to the embodiments determines a subnetwork that connects virtual machines between groups in each group. At this time, the management apparatus adjusts to not set virtual machines of the first group and virtual machines of the second group in the same subnetwork when any one of the virtual machines of the second group does not communicate with the virtual machines of the first group. For example, a virtual machine that is operated as wide area network optimization controllers (WOC, WAN acceleration device) embeds a cache therein. For this reason, a virtual machine that is operated as the WOC does not transmit a packet to a virtual machine that is operated as a cache server. In this case, the management apparatus does not connect a group of a virtual machine that is operated as the WOC and a group of a virtual machine that is operated as a cache to the same subnetwork. In addition, a firewall does not transmit a packet to another firewall. For this reason, when a group of a virtual machine that is operated as the firewall is divided into a plurality of groups due to a difference or the like of a transfer destination, groups of the firewall that are divided into several groups are not connected to the same subnetwork. According to these processing methods, the management apparatus increases the number of virtual machines which can be accommodated in the network.

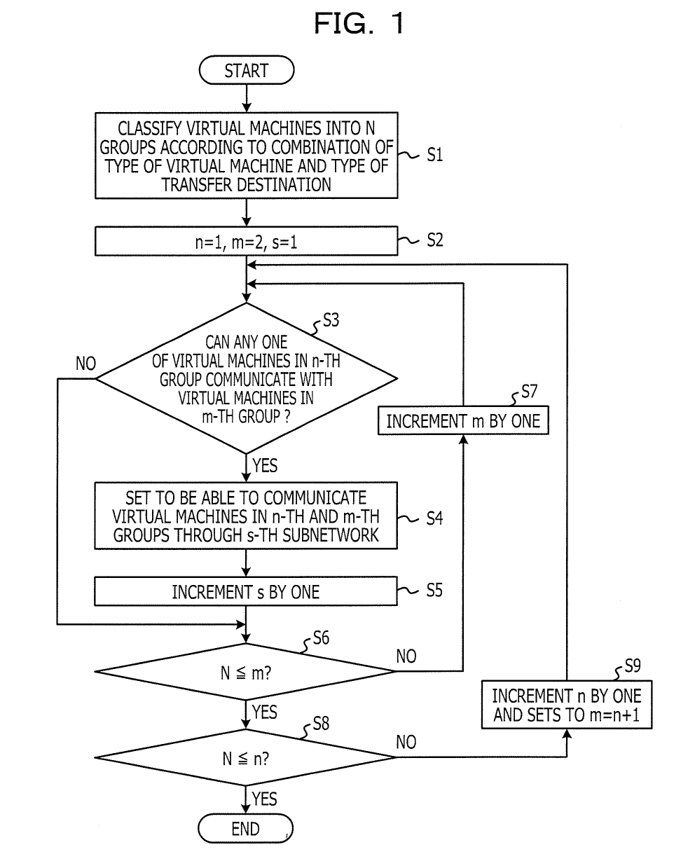

FIG. 1 is a flow chart illustrating an example of a management method according to the embodiment. In the flow chart of FIG. 1, an integer N is the number of groups to be classified the virtual machines, and is an arbitrary number equal to or greater than 2.

First, in the virtual machines included in a service chain in operation, the management apparatus in a network specifies a type of processing that is performed by the virtual machines and a type of processing that is performed at a transfer destination of a packet from the virtual machines. Furthermore, the management apparatus in the network classifies a type of processing, which is performed in each of the virtual machines included in a service chain in operation, into N groups according to types of transfer destination from the virtual machines (step S1).

Next, whether or not virtual machines in groups communicate with virtual machines of any group in each of the groups is analyzed according to a connection condition of each of the service chains in operation. Furthermore, the management apparatus specifies the number of subnetworks used for connecting between groups based on the analyzed result of the communication condition between groups. Processing that is performed in confirmation of the connection condition and the specification of the number of subnetworks will be described with reference to steps S2 to S9.

The management apparatus sets a variable n to 1, a variable m to 2, and a variable s to 1 (step S2). In step S2, the variable n and the variable m are values that are used for specifying two groups for which it is to be determined whether or not the two groups are connected with each other, and the variable s is a value that is used for specifying a subnetwork used in connection between groups. The management apparatus determines whether or not any one of the virtual machines in the n-th group can communicate with the virtual machines in the m-th group (step S3). The management apparatus sets the virtual machines in the n-th and m-th groups to communicate with each other through an s-th subnetwork when any one of the virtual machines in the n-th group can communicate with a virtual machine in the m-th group (Yes in step S3, and step S4). That is, the management apparatus assigns an address for communicating with the s-th subnetwork in the virtual machines in the n-th group and the virtual machines in the m-th group. Then, the management apparatus increments the variable s by 1 (step S5). Meanwhile, the management apparatus does not perform processing of steps S4 and S5 when any one of the virtual machines in the n-th group does not communicate with the virtual machines in the m-th group (No in step S3). In other words, when No is determined in step S3, a subnetwork for connecting the n-th group with the m-th group is not generated.

Then, when a value of the variable m does not reach the total number of groups N, the management apparatus repeats step S3 and subsequent processing by incrementing the value of the variable m by 1 (No in step S6, and step S7). When the value of the variable m reaches the total number of groups N, the management apparatus compares a value of the variable n with the total number of groups N (Yes in step S6, and step S8). When the value of the variable n does not reach the total number of groups N, the management apparatus repeats step S3 and subsequent processing by incrementing the variable n by 1 and by changing the variable m to a variable m with a value one greater than that of the variable n (No in step S8, and step S9). For this reason, by repeating processing of steps S2 to S9, whether communication between other groups and each of N groups can be generated is confirmed and a subnetwork is set in each combination where there is a possibility that communication between the groups can be generated.

In addition, processing illustrated in FIG. 1 is an example. For example, a processing procedure may be changed to perform set processing of virtual machines which is performed according to the virtual machines request the number of subnetworks that are used in the entire subnetwork.

In this way, in a method according to the embodiment, virtual machines are classified into groups, then virtual machines included in two groups in which communication processing between the groups can be generated are included in one subnetwork. Accordingly, since there is no limit that the entirety of virtual machines in the network can be connected to one subnetwork, it is possible to increase the number of virtual machines that are used in the network. Furthermore, a method according to the embodiment can efficiently assign a subnetwork by not setting the subnetwork for communicating between virtual machines of groups where communication is not generated. Since there is an upper limit even in the number of subnetworks which can be set in one communication system, the management apparatus can set the upper limit number of the virtual machines which can be included in the communication system as high as possible by effectively using a subnetwork.

Apparatus Configuration

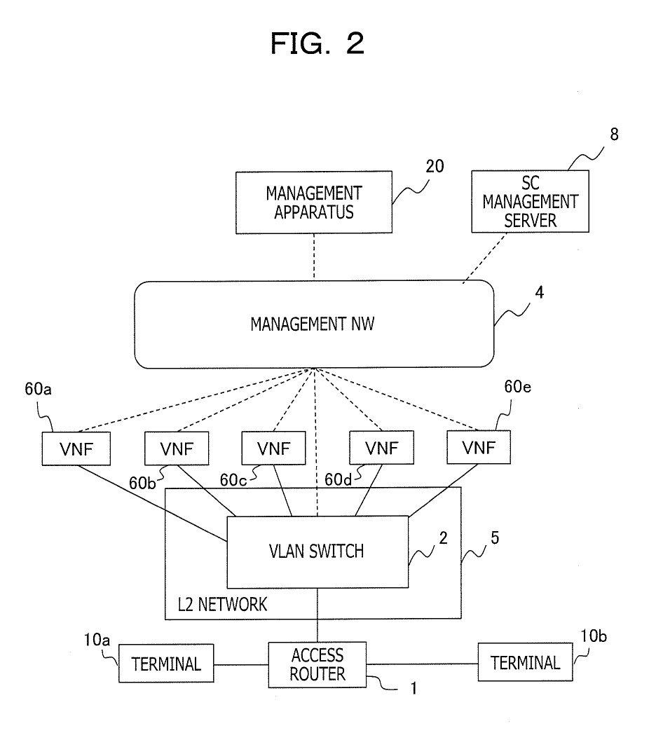

FIG. 2 is a diagram illustrating an example of a communication system. The communication system includes an access router 1, an L2 network 5, VNFs 60 (60a to 60e), a management network 4, a service chain (SC) management server 8, and a management apparatus 20. The access router 1 becomes an access destination of a terminal 10 that uses a service chain. In an example of FIG. 2, a service chain is set in which a packet is transmitted from a terminal 10 a toward a terminal 10b. The SC management server 8 holds information of the service chain realized in the communication system, and appropriately provides the information of the service chain to the management apparatus 20. The management apparatus 20 connects each of VNFs 60 to a subnetwork in each group by using information obtained from the SC management server 8.

Each VNF 60 is realized by the virtual machine and connected to both of the L2 network 5 and the management network 4. In FIG. 2, connections that are used for transmitting and receiving data are represented as solid lines and connections that are used for transmitting and receiving control information used in setting or the like of the subnetwork are represented as dashed lines. The L2 network 5 includes a virtual local area network (VLAN) switch 2. When a VLAN-ID is assigned as a physical connection port in a physical server in which the VLAN switch 2 and each VNF 60 are realized, each VNF 60 is connected to a subnetwork, as a logical network. In addition, when a plurality of VLAN-IDs are assigned to a certain physical port, a VNF 60, which is operated in a server connected to the physical port, is connected to a plurality of subnetworks corresponding to a VLAN-ID that is assigned to the port. In the following description, processing through which a certain VNF 60 is connected to a subnetwork is intended to assign a VLAN-ID of VLAN, to which the VNF 60 is connected, to a port of a VLAN switch 2 to which the server that has realized the VNF 60 is connected.

In addition, FIG. 2 is an example of a communication system, and the number of the access router 1, the terminals 10, the VLAN switch 2, and the VNF 60 can be changed according to an implementation. In addition, a terminal 10 of a starting point side and a terminal 10 of a terminating point side in one service chain may be connected to access routers 1 different from each other when a plurality of the access routers 1 are included in the communication system.

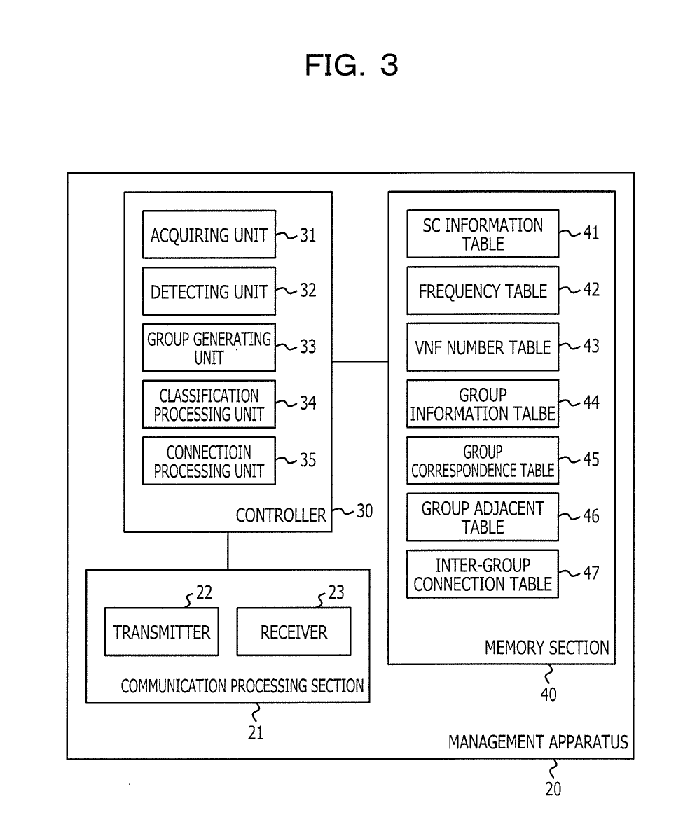

FIG. 3 is a diagram illustrating a configuration example of the management apparatus 20. The management apparatus 20 includes a communication processing section 21, a controller 30, and a memory section 40. The communication processing section 21 includes a transmitter 22 and a receiver 23. The controller 30 includes an acquiring unit 31, a detecting unit 32, a group generating unit 33, a classification processing unit 34, and a connection processing unit 35. The memory section 40 includes an SC information table 41, a frequency table 42, a VNF number table 43, a group information table 44, a group correspondence table 45, a group adjacent table 46, and an inter-group connection table 47. The transmitter 22 transmits control information to the VNF 60 or the VLAN switch 2. The receiver 23 receives control information from the VLAN switch 2, the SC management server 8, the VNF 60, or the like.

The acquiring unit 31 updates the SC information table 41, the frequency table 42, and the VNF number table 43 when acquiring information relating to a service chain from the SC management server 8 through the receiver 23. A type and a path of a virtual machine in a service chain are recorded in the SC information table 41 in association with a combination of an internet protocol (IP) address of a terminal 10 that is a starting point and an IP address of a terminal 10 that is a terminating point in each service chain. Information of the SC information table 41 is information that is obtained from the SC management server 8. Frequency of a combination that occurs in the entire network for each combination of processing content performed in two virtual machines in which transfer processing has been performed in a path that is recorded in the SC information table 41 is recorded in the frequency table 42. A classified result of the number of the VNFs 60 in the network according to a type of processing of the VNF 60 is recorded in the VNF number table 43. An example and a specific example of the update processing in the frequency table 42 and the VNF number table 43 will be described later.

The detecting unit 32 detects a trigger that performs change processing of a group by using the SC information table 41, the frequency table 42, and the VNF number table 43. The trigger, for example, is a state change where the number of connections from a virtual machine that is operated as a firewall to a virtual machine that is operated as a cache server are greatly varied. The state change that is the trigger is determined according to an implementation. The detecting unit 32 requests generation processing of a group to the group generating unit 33 when the trigger is detected. The group generating unit 33 determines the number of groups that are used for the classification of the VNF 60, a type of VNF 60 that is included in each group, or the like by using the frequency table 42 and the VNF number table 43. The group generating unit 33 records the determined information in the group information table 44.

The classification processing unit 34 classifies the VNFs 60 into each group by using the group information table 44 and the SC information table 41. The classification processing unit 34 records the classified result in the group correspondence table 45. The connection processing unit 35 determines whether there is a possibility that communication is generated between two groups that are selected from groups generated using the group correspondence table 45, and records the determined result in the group adjacent table 46. The connection processing unit 35 performs assigning processing of a subnetwork by using the group adjacent table 46, and records the performed result in the inter-group connection table 47. Furthermore, the connection processing unit 35 requests change of an IP address or change of a routing table to the VNF 60. These processing methods will be described in detail later.

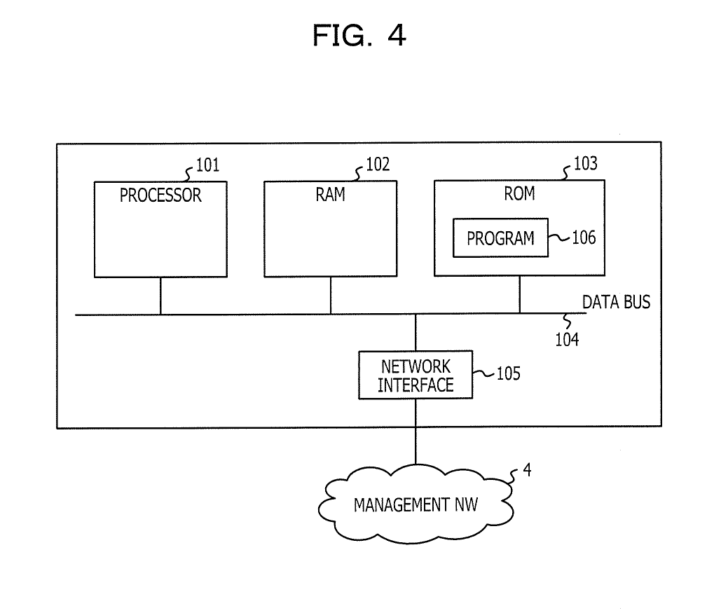

FIG. 4 is a diagram illustrating a hardware configuration example of the management apparatus 20. The management apparatus 20 includes a processor 101, a random access memory (RAM) 102, a read only memory (ROM) 103, a data bus 104, and a network interface 105. The ROM 103 accommodates a program 106. The processor 101 is a processing circuit including a central processing unit (CPU). The processor 101 executes various processing programs by appropriately reading and executing the program 106. The processor 101 appropriately accesses the RAM 102 or the ROM 103 during processing. The data bus 104 connects the processor 101, the RAM 102, the ROM 103, and the network interface 105 so as to exchange data with each other. The processor 101 is operated as the controller 30. The RAM 102 and the ROM 103 are operated as the memory section 40. The network interface 105 is operated as the communication processing section 21.

### First Embodiment

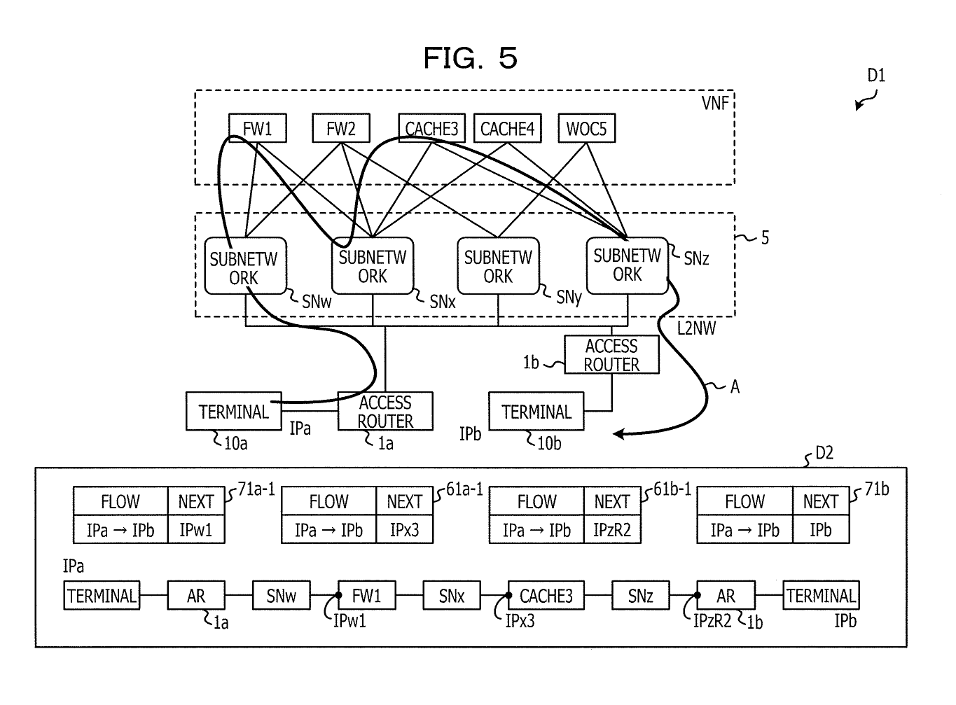

FIG. 5 is a diagram illustrating an example of a service chain. D1 of FIG. 5 is an example of the service chain that is generated when a user of the terminal 10a requests, to an operator, setting of a path that reaches from the terminal 10a to the terminal 10b through a firewall and a cache server. In addition, it is assumed that an address referred to as IPa is assigned in the terminal 10a, and an address referred to as IPb is assigned in the terminal 10b.

An operator generates a service chain that is requested by using the management apparatus 20 or the SC management server 8. When the service chain is generated, a virtual machine that is operated as a VNF 60 included in a new service chain is generated in a physical server that is selected from physical servers in a communication system, and the generated virtual machine is connected using a subnetwork. The virtual machine included in the new service chain notifies content of processing, which is realized as a VNF 60, and a transfer destination of the processed packet along with information of a destination or the like of a packet. A method for generating each service chain is the same as a known method. As the processed result, a service chain illustrated by an arrow A in D1 is obtained.

In the following description, in order to identify each VNF 60, a character string that combines a processing content of the VNF 60 with an identification number of the VNF 60 is used. For example, when a VNF 60 with identification number=1 is operated as a firewall (FW), it is represented as FW 1. Similarly, the Cache 3 represents that a VNF 60 with identification number=3 is operated as a cache server, and the WOC 5 represents that a VNF 60 with identification number=5 is operated as a WAN acceleration device. In the D1, subnetworks SNw to SNz are illustrated. In the following description, an IP address assigned in each VNF 60 represents a combination of a sign, which is illustrated following SN among reference signs of a subnetwork included in a VNF 60, and an identification number of the VNF 60 as a character string obtained following the character string referred to as IP. For example, since FW 1 is included in a subnetwork SNw and has identification number=1, the FW 1 is assigned an address referred as to IPw1.

D2 of FIG. 5 represents a path of a service chain illustrated as an arrow A by linearly rewriting the path. A routing table held by access routers 1 (1a, 1b) and VNFs 60 (FW 1, Cache 3) is illustrated so as to easily view transfer processing in D2. The routing table in each device is set by a device that performs processing for generating a service chain when the service chain is generated. The terminal 10a transmits a packet addressed to the terminal 10b to the access router 1a based on the address of an access router (AR) 1a stored in advance. The access router 1a includes a routing table 71a-1. Information that a packet is addressed from IPa to IPb and transmitted toward IPw1 is set in the routing table 71a-1. For this reason, the packet addressed from the terminal 10a to the terminal 10b is transmitted from the access router 1a to the FW 1. Since information that the packet addressed from the IPa to the IPb is transmitted to IPx3 is set in the routing table 61a-1 held by the FW 1, the FW 1 transmits the packet addressed to the terminal 10b to the Cache 3. Since information that the packet addressed from the IPa to the IPb is transmitted to the IPzR2 is set in the routing table 61b-1 held by the Cache 3, the Cache 3 transmits the packet addressed to the terminal 10b to the access router 1b. Since information that the packet addressed from the IPa to the IPb is transmitted to the IPb is set in the routing table 71b held by the access router 1b, the access router 1b transmits the packet addressed to the terminal 10b to the terminal 10b.

Each service chain operated in the network is the same as FIG. 5. The SC management server 8 stores information in each service chain. The SC management server 8 periodically notifies the management apparatus 20 of the information of the service chain. The acquiring unit 31 of the management apparatus 20 acquires a packet that is received from the SC management server 8 through the receiver 23, and updates the SC information table 41 by using information of the received packet.

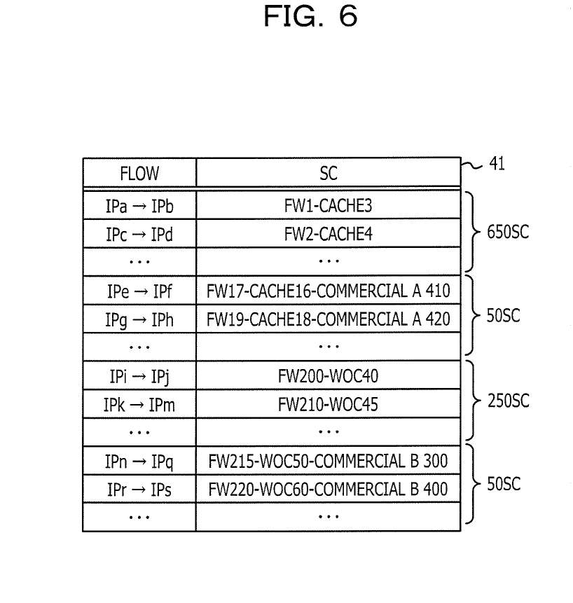

FIG. 6 is a diagram illustrating an example of the service chain (SC) information table 41. The SC information table 41 associates a flow in each service chain in operation with information of VNF 60 included in each service chain. In the example of FIG. 6, the flow of each service chain is represented by a combination of IP addresses assigned in each of a terminal 10 that is a starting point and a terminal 10 that is a terminating point of the service chain. Information of a VNF 60 included in each service chain is information that indicates identification information of the VNF 60 according to an order by which a packet passes through. For example, information of the service chain described with reference to FIG. 5 is recorded in a first entry of the SC information table 41 illustrated in FIG. 6.

In addition, in an example of FIG. 6, a case where the acquiring unit 31 sorts information of each service chain based on a type of a VNF 60 included in each service chain and a passing order is illustrated. However, arrangement of data in the SC information table 41 is optional.

In the example of FIG. 6, 650 service chains are operated in which a packet is transmitted from a VNF 60 operated as an FW to a VNF 60 operated as a cache server. Meanwhile, 50 service chains are operated in which a packet is transmitted by an order of the VNF 60 operated as the FW, the VNF 60 operated as the cache server, and a VNF 60 operated as a server that provides a commercial software A. 250 service chains are operated in which a packet is transmitted from the VNF 60 operated as the FW to a VNF 60 operated as the WAN acceleration device (WOC). Furthermore, 50 service chains are operated in which a packet is transmitted by an order of the VNF 60 operated as the FW, the VNF 60 operated as the WAN acceleration device, and a VNF 60 operated as a server that provides a commercial software B.

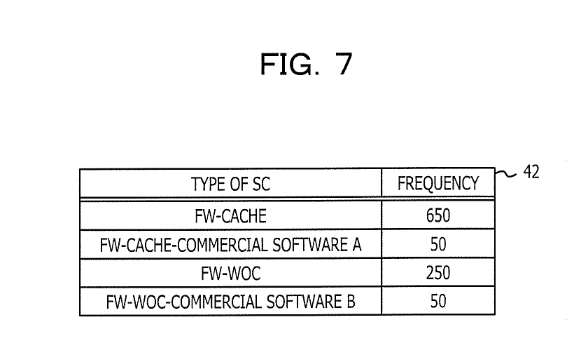

FIG. 7 is a diagram illustrating an example of the frequency table 42. The frequency table 42 associates a type of a service chain with the occurrence frequency of the service chain. The acquiring unit 31 acquires the number of operations in the network from each combination of a type and a passing order of a VNF in the service chain by using the SC information table 41 after updating and updates the frequency table 42. When the SC information table 41 is updated as described in FIG. 6, the acquiring unit 31 generates the frequency table 42 illustrated in FIG. 7. In addition, when the acquiring unit 31 updates the frequency table 42, the detecting unit 32 stores information of the frequency table 42 before updating so as to compare with information after updating.

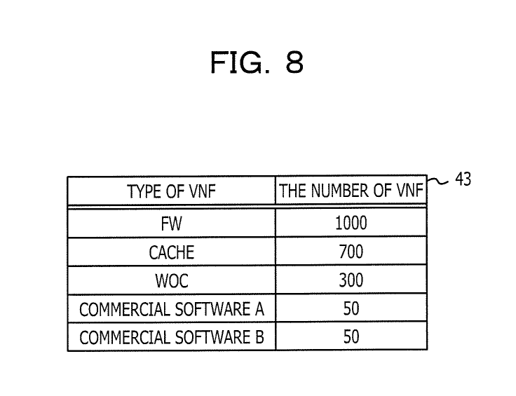

FIG. 8 is a diagram illustrating an example of the VNF number table 43. The VNF number table 43 associates the number of VNFs 60 in operation with a type of VNF 60 included in a service chain in operation. The VNF number table 43 is used when it is determined whether or not VNFs 60 that perform the same type of processing are divided into a plurality of groups in a case where resetting of the group is performed.

The acquiring unit 31 generates the VNF number table 43 by using the SC information table 41 or the frequency table 42. That is, for each type of VNF 60, the total number of service chains included in the type of VNF 60 is obtained. For example, since the number of VNFs 60 is obtained as the total number of a service chain of FW-Cache and a service chain of FW-Cache-commercial software A by using the frequency table 42 (FIG. 7), the number of VNFs 60 operated as a Cache server (Cache) is 700. In addition, since an FW is included in the entire service chain in the frequency table 42, the total number of VNFs 60 operated as the FW is 1000 (650+50+250+50=1000 units). By performing the same processing on the WOC, the commercial software A, and the commercial software B, the acquiring unit 31 generates the VNF number table 43 illustrated in FIG. 8. In addition, even when the acquiring unit 31 updates the VNF number table 43, the detecting unit 32 stores information of the VNF number table 43 before updating so as to compare with information after updating.

The detecting unit 32 obtains the amount of change caused by the updating from the frequency table 42 and the VNF number table 43, and determines whether or not to perform changing of the group. When the amount of change exceeds a threshold, the detecting unit 32 requests resetting of the group and a change of connection to the group generating unit 33. In addition, a threshold for determining whether change processing of the group is performed may be set according to an implementation. Here, when a service chain is newly set, it is assumed to not determine which VNF 60 in each service chain is included in a subnetwork by using a type of other VNF 60 in the subnetwork. In this case, when the number of the service chains that are newly set exceeds a predetermined amount, operation is not effectively performed. Furthermore, when operation of the service chain terminates, since the VNF 60 used in the service chain is discarded, an assignment of a type of VNF 60 in the subnetwork is changed. A threshold used in the detecting unit 32 is experimentally set based on disadvantages caused from a subnetwork not optimized in accordance with these changes and a processing load generated from the resetting of the group.

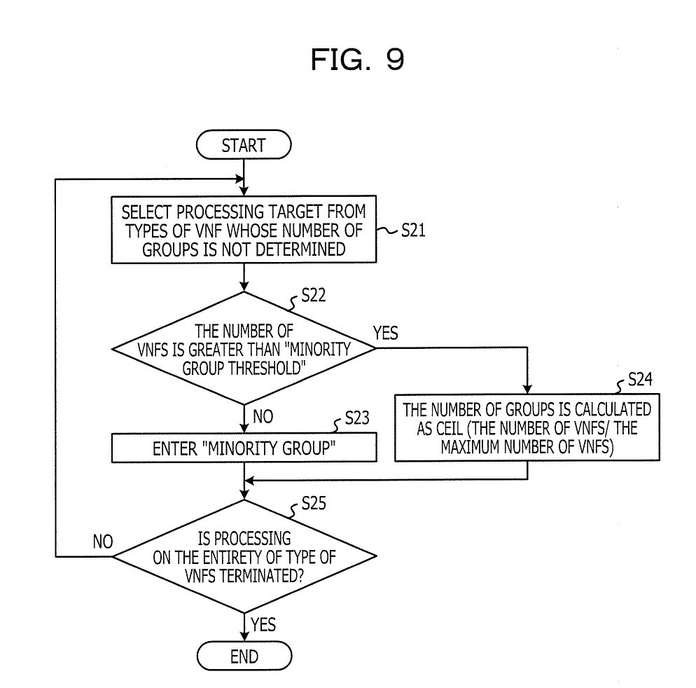

FIG. 9 is a diagram illustrating an example of a method for generating group information. An example of processing that is performed by the group generating unit 33 when resetting of the group is requested will be described with reference to FIG. 9. In addition, in the example of FIG. 9, a threshold referred as to a minority group threshold is used. The group generating unit 33 classifies a type of VNF that does not include only VNF 60 s of a number smaller than that of the minority group threshold into one group (minority group).

The group generating unit 33 selects a processing target from a type of VNF whose number of groups is not determined, with reference to the VNF number table 43 (step S21). Next, the group generating unit 33 determines whether or not the number of VNFs is greater than the minority group threshold in association with the type of VNF of the processing target (step S22). When the number of VNFs is less than the minority group threshold, the group generating unit 33 classifies a VNF 60 of the type of VNF of the processing target into a minority group (No in step S22, and step S23). Meanwhile, when the number of VNFs exceeds the minority group threshold, the group generating unit 33 calculates the number of groups that are used in the type of VNF of the processing target (No in step S22). The group generating unit 33 obtains the number of groups used for classifying the VNF 60 of the type of the processing target by using the total number of the VNFs 60 (the number of VNFs) of the type of VNF of the processing target and a maximum value (the maximum number of VNFs) of the VNFs 60 that are accommodated in one group. In the example of FIG. 9, the number of groups is calculated as a ceil (the number of VNFs/the maximum number of VNFs) (step S24). In addition, the maximum number of VNFs is set to a number that is less than half the number of the VNFs 60 which can be included in one subnetwork. When processing of step S23 or step S24 is terminated, the group generating unit 33 determines whether or not processing of the entirety of types of VNFs is terminated (step S25). When the processing of the entirety of types of VNFs is not terminated, the group generating unit 33 repeats step S21 and subsequent processing (No in step S25). Meanwhile, when processing of the entirety of types of VNFs is terminated, the group generating unit 33 terminates processing (Yes in step S25).

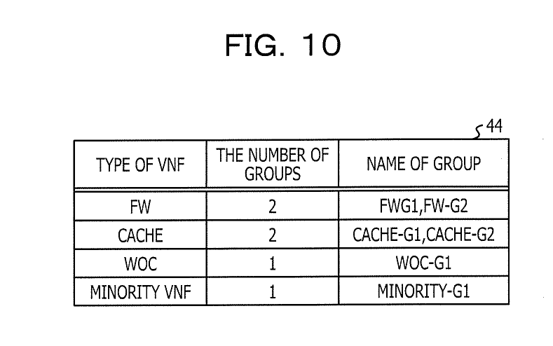

FIG. 10 is a diagram illustrating an example of the group information table 44. The group information table 44 records the number of groups and a group name for each type of VNF. The number of groups is determined by a procedure described with reference to FIG. 9. The group name is information that uniquely indentifies each group. For example, it is assumed that the maximum number of VNFs is 500 and a priority group threshold value is 100. In this case, as FIG. 8 and FIG. 9, two groups are used for classifying the VNF 60 operated as the FW and two groups are also used for classifying the VNF 60 operated as a cache server. Meanwhile, when a type of VNF is WOC, the number of the group is 1. In addition, since the number of VNFs is less than a priority group threshold, all of the number of VNFs 60 of a type of VNF=commercial software A and a VNF 60 of a type of VNF=commercial software B are classified into the priority group. In FIG. 10, the VNF classified into the priority group is recorded as a type of VNF=priority VNF. In addition, the name of each group is illustrated in a field of the group name of the group information table 44. For example, the name of one of a group of a type of VNF=FW is FW-G1, and the name of the other is FW-G2. The group generating unit 33 requests classification processing of the VNF 60 to the classification processing unit 34 when updating the group information table 44.

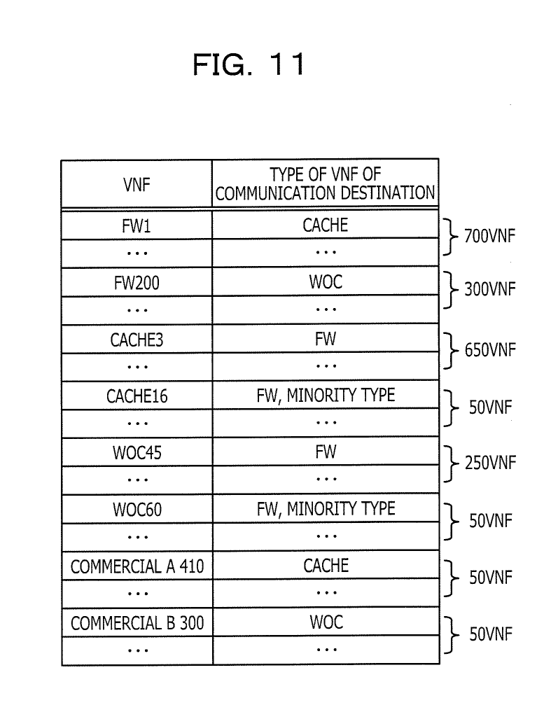

FIG. 11 is a diagram illustrating an example of a table illustrating a specification method example of a type of a VNF communication destination. The classification processing unit 34 specifies the type of the VNF communication destination of each VNF 60 by using the SC information table 41 (FIG. 6) so as to classify the VNF 60. For example, since an FW 1 communicates with a Cache 3 (first entry in FIG. 6), the type of the communication destination of the FW 1 is the Cache. Accordingly, in the entry for the FW 1, the type of the communication destination is the Cache. Similarly, even for other VNFs 60, a type of VNF 60 to be a communication destination in the SC information table 41 is specified. In addition, when a communication destination is specified to correspond to bidirectional communication, the classification processing unit 34 also deals with the VNF 60 of a connection destination in a reverse direction on a flow direction of the SC information table 41 in the same manner as the VNF 60 of the transfer destination of a packet. For example, in a flow that reaches from IPa to IPb, a packet is transmitted from the FW 1 to the Cache 3. However, the classification processing unit 34 determines whether or not the Cache 3 also communicates with the FW 1. For this reason, in FIG. 11, a type of the communication destination of the Cache 3 is FW. In addition, the communication destination may be plural. For example, in a flow reaching from the IPr to the IPs, a packet is transmitted along a path through the FW 220, the WOC 60, and the commercial B 400 in order. For this reason, the classification processing unit 34 determines whether or not the WOC 60 communicates with both of the FW 200 and the commercial B 400. Accordingly, in FIG. 11, it is determined that a type of the communication destination of the WOC 60 is the FW and the minority type. In addition, which type of VNF 60 is included in the minority type is notified from the group generating unit 33 to the classification processing unit 34. Meanwhile, in the flow reaching from IPr to IPs, the commercial B 400 performs directly transmitting and receiving a packet to and from the WOC 60, but does not perform directly transmitting and receiving the packet to and from the FW 220. For this reason, the classification processing unit 34 determines that a type of the communication destination is only the WOC for the commercial B 400.

The classification processing unit 34 sorts an order of information depending on a type of the communication destination as a key, and obtains the number in each combination of a type of the VNF 60 and a type of the communication destination of the VNF 60 when specifying the communication destination. In the example of FIG. 11, the number of VNFs is 700, which communicate with the Cache, and is 300, which communicate with the WOC, in the VNF 60 operated as the FW. Similarly, the number of VNFs is 650, which communicate with only the FW, and is 50, which communicate with a VNF 60 (minority type) that is classified into the FW and the minority group, in the VNF 60 operated as the Cache. In addition, the number of VNFs is 250, which communicate with only the FW, and is 50, which communicate with the VNF 60 of the FW and the minority group, in the VNF 60 operated as the WOC.

The classification processing unit 34 classifies VNFs 60 with the same combination as a combination of a type of the VNF 60 and a type of a communication destination of the VNF 60 into the same group as much as possible based on information of FIG. 11. In addition, VNFs 60 of a number less than the maximum number of the VNF 60 are assigned in each group. Here, the maximum number of the VNFs is 500, and the number of the VNFs that communicate with the Cache in the FW is 700. For this reason, 200 FWs that communicate with the Cache are classified into the same group as the FW that communicates with the WOC. The same processing is performed on the Cache.

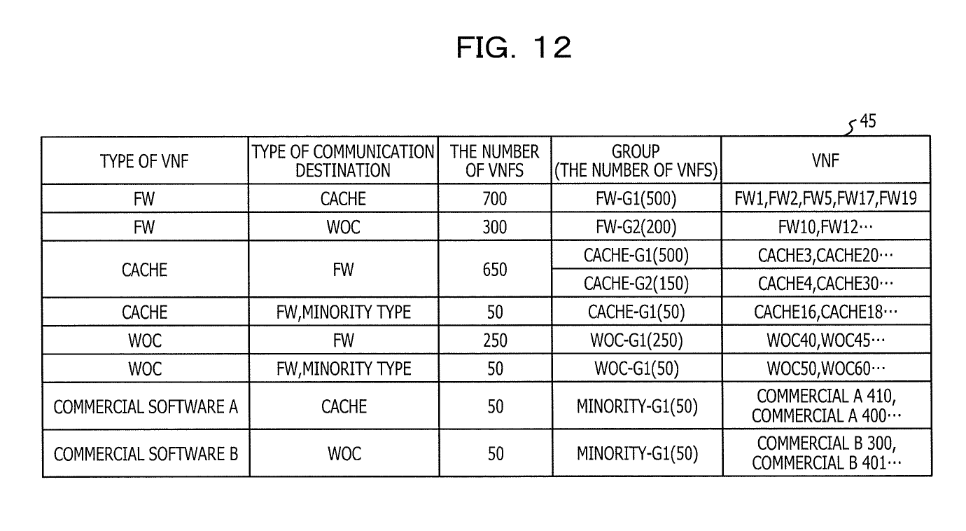

FIG. 12 is a diagram illustrating an example of a group correspondence table 45. The group correspondence table 45 records a result of grouping that is performed by the classification processing unit 34. In the group correspondence table 45, a name or the like of a group of a classification destination is recorded in a combination of a type of VNF and a type of a communication destination. Furthermore, a VNF that is classified into a group of a name in association with the name of each group is recorded. For example, 500 FWs that communicate with the Cache are classified into a group with a name referred to as the FW-G1. In addition, VNFs 60 such as FW 1, FW 2, FW 5, FW 17, and FW 19 are included in the FW-G1. 200 FWs that are not classified into the FW-G1 in the FWs that communicate with the Cache are classified into the FW-G2. FW 10, FW 12, and the like are included in the FW-G2. All FWs that communicate with the WOC are classified into the FW-G2. For this reason, FW 200, FW 210, FW 215, FW 220, and the like are included in the FW-G2.

The VNF 60 operated as the cache server also performs the same processing. For this reason, 500 Caches that communicate with the FW are classified into a group with a name referred to as Cache-G1. VNFs 60 such as Cache 3 and Cache 20 are included in the Cache-G1. 150 VNFs 60 that are not classified into the Cache-G1 in the Caches that communicate with the FW are classified into the Cache-G2. Cache 4, Cache 30, or the like is included in the Cache-G2. All Caches that communicate with both the FW and the minority type (VNF 60 providing the commercial software A or the commercial software B) are classified into the Cache-G2. For this reason, Cache 16, Cache 18, or the like is included in the Cache-G2.

One group is used for classifying a VNF 60 operated as the WOC. For this reason, a WOC that communicates with only an FW and a WOC that communicates with both VNFs 60 of an FW and a minority type are classified into a group of the WOC-G1. WOC 40, WOC 45, WOC 50, WOC 60, or the like is included in the WOC-G1.

A VNF 60 that has been classified into the minority type is classified into one group (minority-G1). For this reason, VNFs 60 that have provided the commercial software A and the commercial software B are classified into a group of the minority-G1. Commercial A 410, commercial A 400, commercial B 300, commercial B 401, or the like is included in the minority-G1.

The classification processing unit 34 notifies a connection processing unit 35 that updating of the group is terminated when the updating of the group correspondence table 45 is terminated. The connection processing unit 35 performs determination of a subnetwork including VNF 60 of each group, and setting processing of each VNF 60 such that each VNF 60 of the groups that are newly generated can perform communication processing. Hereinafter, processing of the connection processing unit 35 is divided into processing for obtaining a connection relationship between groups and processing for performing a setting change to the VNF 60, and the processing will be described in detail.

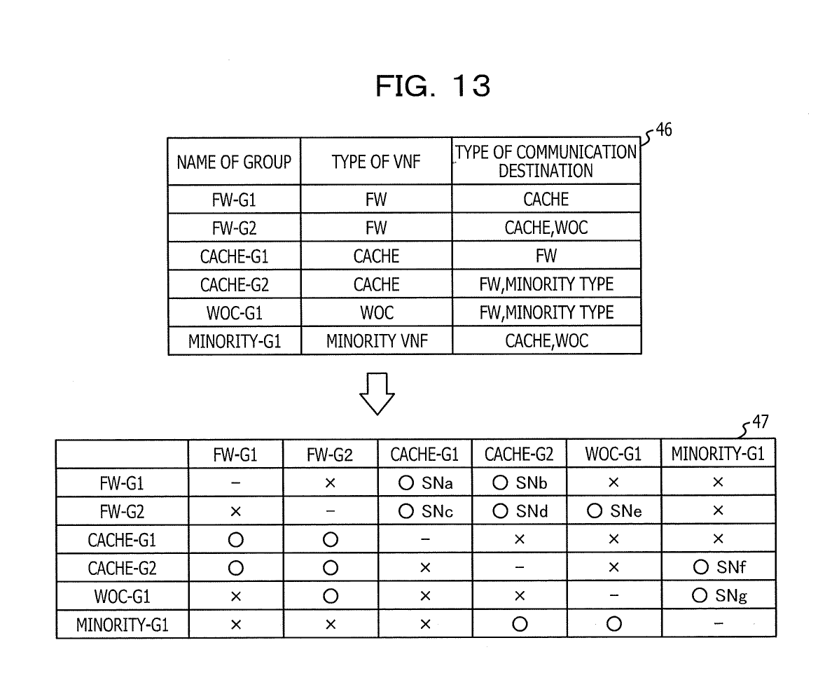

FIG. 13 is a diagram illustrating an example of a method for obtaining the connection relationship between groups. The connection processing unit 35 generates the group adjacent table 46 from the group correspondence table 45. The group adjacent table 46 records a group name, a type of VNF, and a type of a communication destination for each group therein. The type of VNF is a type of VNF of a VNF 60 that is included in a group thereof. The type of the communication destination is a type of the communication destination of a VNF 60 that is included in a group thereof. For example, since a VNF 60 that is included in an FW-G1 is an FW and the VNF 60 that is classified into the FW-G1 communicates with a Cache, information of the FW-G1 is represented as the first entry in the group adjacent table 46 of FIG. 13. Meanwhile, a VNF 60 that is included in an FW-G2 is an FW, and a part of the VNF 60 that has been classified into the FW-G2 communicates with a Cache, but the other of the VNF 60 communicates with a WOC. For this reason, information of the FW-G2 is represented as the second entry. Since a VNF 60 operated as a Cache is classified into a Cache-G1, and the VNF 60 classified into the Cache-G1 communicates with an FW, information of the Cache-G1 is represented as the third entry. A VNF 60 included in a Cache-G2 is a Cache, and a part of the VNF 60 communicates with an FW, but others of the VNF 60 communicate with a VNF 60 of a minority type. For this reason, information of the Cache-G2 is represented as the fourth entry. A VNF 60 included in a WOC-G1 is a WOC, and a part of the VNF 60 communicates with the FW, but others of the VNF 60 communicate with a VNF 60 of a minority type. For this reason, information of the WOC-G1 is represented as the fifth entry in the group adjacent table 46. A VNF 60 included in a minority-G1 performs processing that is classified into a minority type, and a part of the VNF 60 communicates with a Cache, but others of the VNF 60 communicate with a WOC. For this reason, information of the minority-G1 is represented as the sixth entry in the group adjacent table 46.

When generation of the group adjacent table 46 terminates, the connection processing unit 35 determines whether or not a subnetwork is assigned by using information of a communication destination of VNF 60 in each group. That is, the connection processing unit 35 specifies a group including a VNF 60 having a possibility that the VNF 60 of the group communicates with each group in the group adjacent table 46. Hereinafter, a specific example of processing performed in the connection processing unit 35 will be described.

For example, a communication destination of a VNF 60 included in a group of an FW-G1 is any one of the VNFs 60 operated as a Cache. The VNF 60 operated as the Cache is classified into one of Cache-G1 or Cache-G2. Therefore, the connection processing unit 35 determines to generate a subnetwork through which VNFs 60 of an FW-G1 and a Cache-G1 communicate with each other and a subnetwork through which VNFs 60 of an FW-G1 and a Cache-G2 communicate with each other. The connection processing unit 35 records information between the groups that generate the subnetwork in the inter-group connection table 47.

The inter-group connection table 47 associates the presence or absence of setting of a subnetwork with each combination of groups having a possibility to be connected. The connection processing unit 35 records information that indicates settings of a subnetwork in a field of a combination of the FW-G1 and the Cache-G1 and a field of a combination of the FW-G1 and the Cache-G2, in the inter-group connection table 47. In the example of FIG. 13, a circle mark indicates a combination that sets a subnetwork, and an x mark indicates a combination that does not set a subnetwork. The connection processing unit 35 also determines an identifier of a subnetwork to be set. Here, the identifier of the subnetwork may be a value which can uniquely identify the subnetwork to be set, for example, a network address. In the inter-group connection table 47 of FIG. 13, an identifier of a subnetwork is also illustrated. In an example of FIG. 13, an identifier of a subnetwork used in communication of the FW-G1 and the Cache-G1 is SNa, and an identifier of a subnetwork used in communication of the FW-G1 and the Cache-G2 is SNb. The connection processing unit 35 also performs the same processing on other groups.

A communication destination of a VNF 60 included in a group of an FW-G2 is one of the VNF 60 operated as a Cache or a VNF 60 operated as a WOC. The VNF 60 operated as the Cache is classified into a Cache-G1 or a Cache-G2. In addition, a VNF 60 operated as a WOC is classified into the WOC-G1. Therefore, the connection processing unit 35 determines to generate a subnetwork that is used in each of communication between the FW-G2 and the Cache-G1, communication between the FW-G2 and the Cache-G2, and communication between the FW-G2 and the WOC-G1. As illustrated in FIG. 13, in the following description, a subnetwork SNc is used in the communication between the FW-G2 and the Cache-G1, and a subnetwork SNd is used in the communication between the FW-G2 and the Cache-G2. Furthermore, a subnetwork SNe is used in the communication between the FW-G2 and the WOC-G1.

A communication destination of a VNF 60 that is included in a group of the Cache-G1 is one of the VNFs 60 operated as an FW. Therefore, the connection processing unit 35 determines that a subnetwork is used in communication between the Cache-G1 and the FW-G1 and communication between the Cache-G1 and the FW-G2. However, since these subnetworks are terminated until an identifier of the subnetwork is determined when the determination processing on the FW-G1 and the FW-G2 is performed, the connection processing unit 35 terminates processing on the Cache-G1.

A communication destination of a VNF 60 included in the group of the Cache-G2 is one of a VNF 60 operated as the FW or a VNF 60 of minority-G1. Therefore, the connection processing unit 35 determines that a subnetwork is used in each of communication between the Cache-G2 and the FW-G1, communication between the Cache-G2 and the FW-G2, and communication between the Cache-G2 and the minority-G1. Processing is terminated until an identifier is determined on a subnetwork that is used in communication between the Cache-G2 and the FW-G1, and between the Cache-G2 and the FW-G2. For this reason, the connection processing unit 35 records in the inter-group connection table 47 that a subnetwork is used in the communication between the Cache-G2 and the minority-G1. A subnetwork SNf is used in the communication between the Cache-G2 and the minority-G1.

A communication destination of a VNF 60 included in the WOC-G1 is any one of a VNF 60 operated as an FW or a VNF 60 of minority-G1. Here, since an FW that communicates with a WOC is classified into the FW-G2 by information of the group adjacent table 46, the connection processing unit 35 determines to set a subnetwork that is used for communicating between the WOC-G1 and the FW-G2. Meanwhile, since a WOC is not included in a communication destination of a VNF 60 in the FW-G1, the connection processing unit 35 determines that the communication destination of the VNF 60 in the WOC-G1 is not included in the FW-G1. Therefore, the connection processing unit 35 determines that a communication subnetwork is not generated between the WOC-G1 and the FW-G1. Furthermore, the connection processing unit 35 determines that a subnetwork is used in communication between the WOC-G1 and the minority-G1. Here, since processing on a subnetwork that is used in communication between the WOC-G1 and the FW-G2 is terminated, the connection processing unit 35 records in the inter-group connection table 47 that a subnetwork is used in communication between the WOC-G1 and the minority-G1. A subnetwork SNg is used in the communication between the WOC-G1 and the minority-G1.

A communication destination of a VNF 60 included in the minority-G1 is one of a VNF 60 operated as a Cache or a VNF 60 in WOC-G1. Here, since a Cache that communicates with a VNF 60 in the minority-G1 is classified into a Cache-G2 by information of the group adjacent table 46, the connection processing unit 35 determines to set a subnetwork that is used in communication between the minority-G1 and the Cache-G2. Meanwhile, since a communication destination of a VNF 60 in the minority-G1 is not included in a communication destination of a VNF 60 in the Cache-G1, the connection processing unit 35 determines that a communication subnetwork is not generated between the minority-G1 and the Cache-G1. Furthermore, the connection processing unit 35 also determines that a subnetwork is used in communication between the minority-G1 and the WOC-G1. Here, since setting of an identifier on each subnetwork or recording in the inter-group connection table 47 is terminated, the connection processing unit 35 terminates processing relating to the minority-G1.

The connection processing unit 35 requests changing an IP address and a transfer destination to the VNF 60 in each service chain included in the SC information table 41 by using a connection relationship of a group and an assignment result of a subnetwork. Hereinafter, processing on the service chain that reaches from a terminal 10 a to a terminal 10 b illustrated in FIG. 5 will be described as an example. The connection processing unit 35 specifies that a packet is transmitted in order of FW 1 and Cache 3 in a service chain that reaches from IPa to IPb by using the SC information table 41 (FIG. 6). In addition, the connection processing unit 35 stores in advance that the terminal 10a communicates through the access router 1a and the terminal 10b communicates through the access router 1b. It is assumed that the connection processing unit 35 determines to connect the access router 1a and the access router 1b with the subnetwork SNa because the FW 1 and the Cache 3 communicate with each other through the subnetwork SNa. Furthermore, the connection processing unit 35 determines an IP address that is assigned in each VNF 60 for each VNF 60 by using a network address in a subnetwork that is used in communication and an identification number of the VNF 60. In addition, the IP address that is used in the subnetwork SNa is assigned for the access routers 1a and 1b. For example, the connection processing unit 35 assigns the following address to each device.

| | |
|---|---|
| Access router 1a | IPaR1 |
| FW 1 | IPa1 |
| Cache 3 | IPa3 |
| Access router 1b | IPaR2 |

The connection processing unit 35 notifies each device of the assigned IP address. Furthermore, the connection processing unit 35 notifies the access router 1a, the FW 1, and the Cache 3 of an IP address of a transfer destination of a packet. That is, the connection processing unit 35 requests, to the access router 1a, to change from a transfer destination address of a packet, which is addressed from IPa to IPb, to the IPa1. Similarly, the connection processing unit 35 requests, to the FW 1, to change from the transfer destination address of the packet, which is addressed from the IPa to the IPb, to the IPa3. Furthermore, the connection processing unit 35 requests, to the Cache 3, to change from the transfer destination address of the packet, which is addressed from the IPa to the IPb, to the IPaR2. In addition, a packet format that is used in the notification processing is a certain format that is used for notifying an address or a transfer destination.

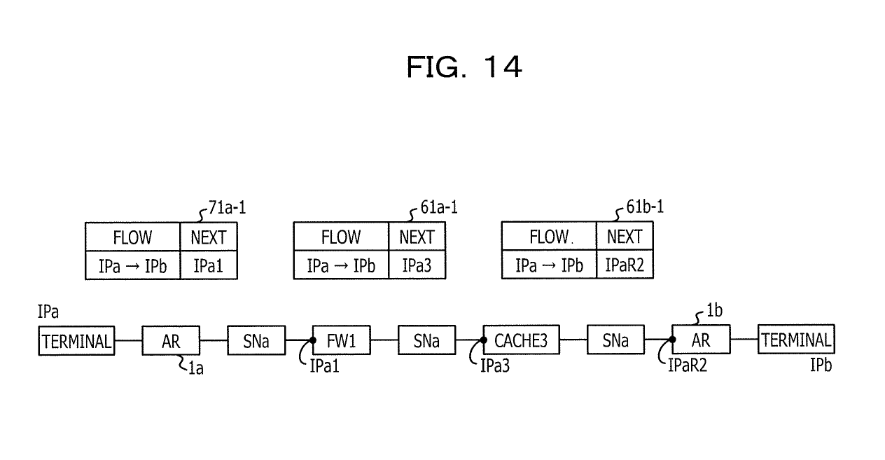

FIG. 14 is a diagram illustrating an example of a service chain. FIG. 14 illustrates an example in a case where a service chain that reaches from the terminal 10a to the terminal 10b illustrated in FIG. 5 is changed by processing of the connection processing unit 35. An IP address and a transfer destination are notified from the management apparatus 20, and thereby the access router la uses the IPaR as an address in communication through a subnetwork SNa and updates a routing table. That is, since the transfer destination address of a packet addressed from the IPa to the IPb is changed to the IPa1, the access router 1a updates the routing table 71a-1 (FIG. 5) to a routing table 71a-2 (FIG. 14). Similarly, the FW 1 sets an IP address and updates the routing table 61a-1 (FIG. 5) to a routing table 61a-2 (FIG. 14). The Cache 3 sets an IP address and updates the routing table 61b-1 (FIG. 5) to a routing table 61b-2 (FIG. 14). Furthermore, the access router 1b sets an address that is notified from the management apparatus 20. In addition, a communication path from the terminal 10a to the access router 1a and a communication path from the access router 1b to the terminal 10b are not changed even in a case of a change of group. For this reason, the packet to be transmitted from the terminal 10a to the terminal 10b reaches from the access router 1a to the terminal 10b through the FW 1, the Cache 3, and the access router 1b.

The connection processing unit 35 of the management apparatus 20 performs the same processing as processing described with reference to FIG. 13 and FIG. 14 on other service chains. For this reason, the management apparatus 20 can improve the efficiency of network connection and continuously provide service by a service chain in operation by optimizing the number of subnetworks that are used in communication between the VNFs 60 in operation.

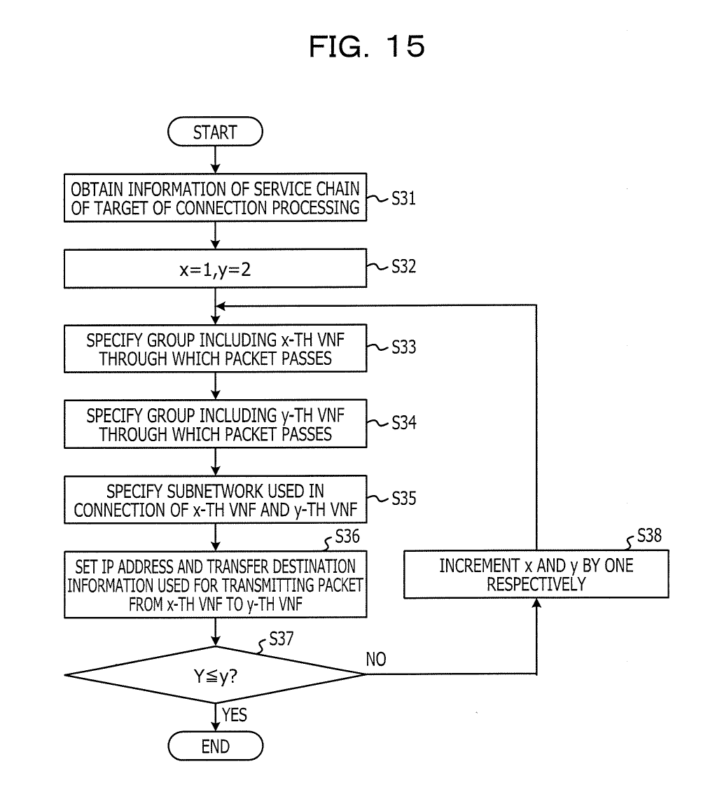

FIG. 15 is a flow chart illustrating an example of connection processing. Variable x, variable y, and integer Y are used in the flow chart illustrated in FIG. 15. The variables x and y are used for specifying a number that is used for setting processing in the VNFs 60 included in a service chain of a processing target. The integer Y is the total number of the VNFs 60 included in the service chain of the processing target.

First, the connection processing unit 35 obtains information of a service chain of a target of connection processing from the SC information table 41 (FIG. 6) (step S31). The connection processing unit 35 sets the variable x to 1 and the variable y to 2 (step S32). The connection processing unit 35 specifies a group including an x-th VNF 60 through which a packet passes in a service chain of a processing target by using the group correspondence table 45 (step S33). The connection processing unit 35 specifies a group including a y-th VNF 60 through which a packet passes in the service chain of the processing target by using the group correspondence table 45 (step S34). The connection processing unit 35 specifies a subnetwork that is used in connection of an x-th VNF 60 and a y-th VNF 60 (step S35). Furthermore, the connection processing unit 35 sets an IP address and transfer destination information that are used for transmitting a packet from the x-th VNF 60 to the y-th VNF 60 (step S36). That is, when there is an unset IP address for at least one of the x-th VNF 60 to the y-th VNF 60, the unset IP address is notified to the VNF 60 that uses the IP address. Furthermore, an IP address that is assigned in the y-th VNF 60 is set to the x-th VNF 60 as an IP address of a transfer destination of the packet. The connection processing unit 35 compares the variable y and the integer Y (step S37). When the variable y is less than the integer Y, the connection processing unit 35 increments the variable x and the variable y by one, respectively, and repeats step S33 and subsequent processing (No in step S37, and step S38). When the variable y is equal to or greater than the integer Y, the connection processing unit 35 determines whether or not a setting of the entirety of VNFs 60 included in the service chain terminates or not and terminates processing (Yes in step S37).

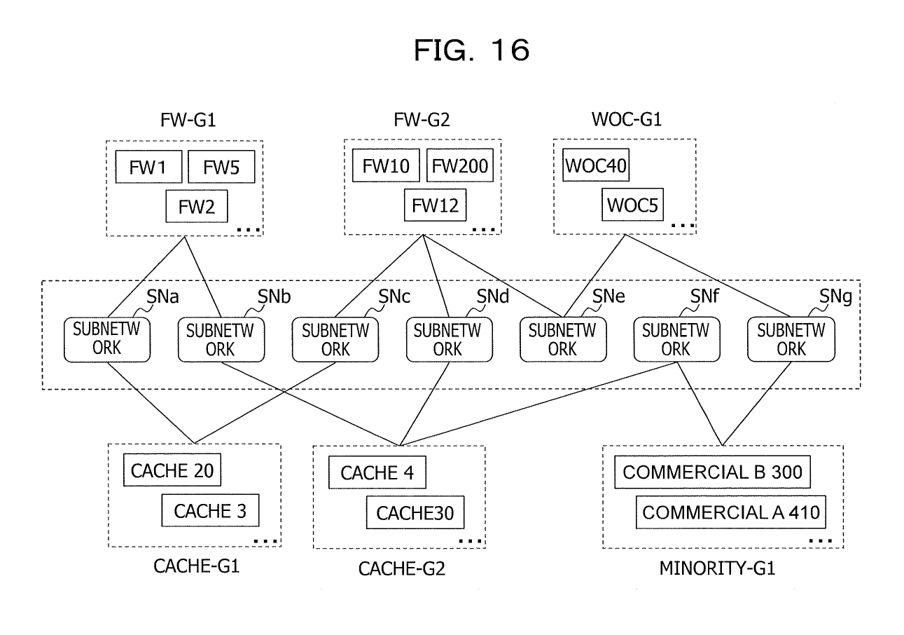

FIG. 16 is a diagram illustrating an example of a network obtained by the connection processing. A connection as illustrated in FIG. 16 is obtained based on a result performed by change of a transfer destination, a setting of an address, or the like with respect to the VNF 60 in each service chain that is included in the SC information table 41 (FIG. 6). That is, an address included in the subnetwork SNa is assigned in a VNF 60 in the FW-G1 and a VNF 60 in the Cache-G1. For this reason, the VNF 60 in the FW-G1 and the VNF 60 in the Cache-G1 communicate with each other through the subnetwork SNa. In addition, an address included in a subnetwork SNb is assigned in a VNF 60 in the FW-G1 and a VNF 60 in the Cache-G2. For this reason, the VNF 60 in the FW-G1 and the VNF 60 in the Cache-G2 communicate with each other through the subnetwork SNb. Similarly, the VNF 60 in the FW-G2 and the VNF 60 in the Cache-G1 communicate with each other through the subnetwork SNc. A VNF 60 in the FW-G2 and a VNF 60 in the Cache-G2 communicate with each other through a subnetwork SNd. A VNF 60 in the FW-G2 and a VNF 60 in the WOC-G1 communicate with each other through a subnetwork SNe. A VNF 60 in the Cache-G2 and a VNF 60 in the minority-G1 communicate with each other through a subnetwork SNf. Furthermore, a VNF 60 in the WOC-G1 and a VNF 60 in the minority-G1 communicate with each other through a subnetwork SNg.

Here, an increase effect of the number of accommodations in the VNF 60 (virtual machine) of the subnetwork according to the first embodiment will be described. For example, when the total number of VNFs 60 available for a load in each device included in one broadcast domain is 1000, since the entirety of VNFs 60 are connected to one subnetwork in a case where the first embodiment be preferably used, it is difficult to include VNFs 60 of a number equal to or greater than 1000 in one subnetwork.

Meanwhile, in the first embodiment, the maximum number of VNFs 60 of each group is limited to 500 so as to become 1000 that is the maximum number of VNFs 60 included in one subnetwork. In addition, each subnetwork is used in communication between two groups, but not used in communication with other groups. For this reason, as illustrated in FIG. 16, when subnetworks SNa to SNg are used, the number of VNFs 60 in each subnetwork may be within 1,000. For this reason, it is possible to increase the number of VNFs 60 included in the one subnetwork when the first embodiment is used, and communication is efficiently performed. For example, in the description used in FIG. 6 to FIG. 16, the number of VNFs 60 included in the entire network is the total number of VNFs 60 in each type of VNF. For this reason, the total number of VNFs 60 in the network is 2,100 (1,000 (FW)+700 (Cache)+300 (WOC)+50 (commercial software A)+50 (commercial software B)=2,100 units) according to the VNF number table 43 (FIG. 8). Accordingly, it is possible to accommodate, in one network, VNFs 60 equal to or greater than double a case where the first embodiment is not used, when the first embodiment is used. In addition, the description used in FIG. 6 to FIG. 16 is only a processing example. Accordingly, it is possible to implement a network that further uses the number of VNFs 60 by further increasing the number of the used subnetworks.

### Second Embodiment

In a second embodiment, an example of a network in which a router is included will be described. It is possible to increase the number of VNFs 60 included in a network by relaying communication, through a router, between groups of a smaller number of VNFs.

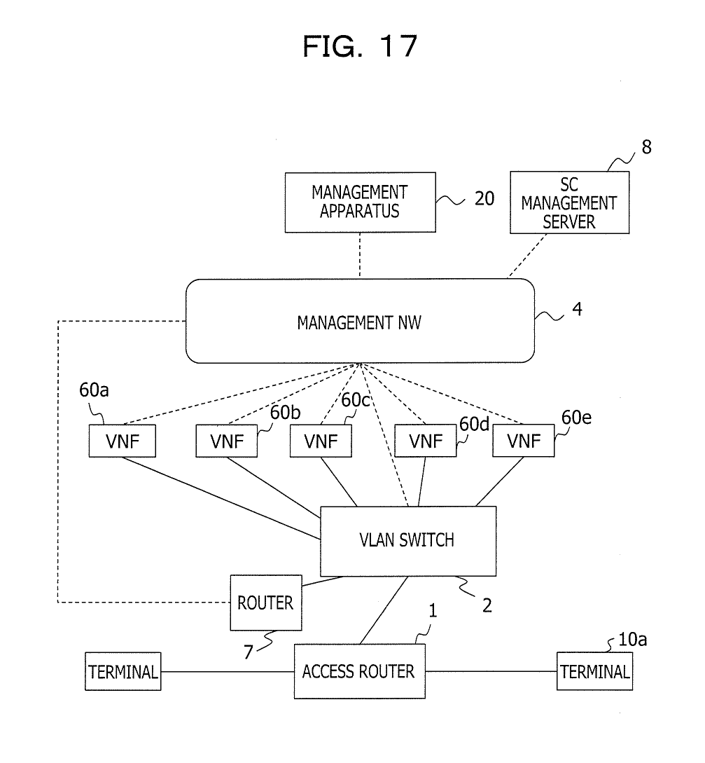

FIG. 17 is a diagram illustrating an example of a communication system in which the second embodiment is applied. The communication system includes an access router 1, a VLAN switch 2, a router 7, VNFs 60 (60a to 60e), a management network 4, an SC management server 8, and a management apparatus 20. In FIG. 17, connections used in transmitting and receiving data are represented as solid lines, and connections used in transmitting and receiving control information that are used in setting or the like of a subnetwork are represented as dotted lines. In addition, FIG. 17 is an example of a communication system, and the number of the access router 1, a router 7, a terminal 10, the VAN switch 2, and the VNFs 60 may be arbitrarily obtained according to an implementation.

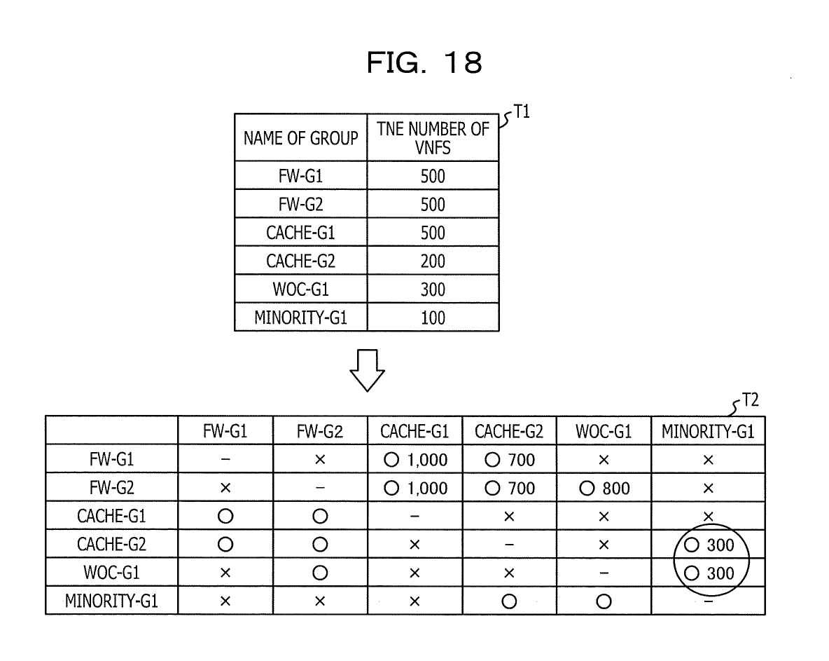

FIG. 18 is a diagram illustrating an example of a method for obtaining a connection relationship between groups. In the second embodiment, processing in the acquiring unit 31, the detecting unit 32, the group generating unit 33, and the classification processing unit 34 of the management apparatus 20 is the same as the first embodiment. In addition, a generation method of the SC information table 41, the frequency table 42, the VNF number table 43, the group information table 44, and the group correspondence table 45 is also the same as the first embodiment.

A table T1 of FIG. 18 is obtained by extracting a group name and a value of the number of VNFs in the group correspondence table 45 (FIG. 12) generated from the SC information table 41 illustrated in FIG. 6. The connection processing unit 35 generates the group adjacent table 46 (FIG. 13), and records a combination of a group in which communication is performed in the inter-group connection table 47, by the same procedure as the first embodiment. In addition, the connection processing unit 35 does not assign a subnetwork at this time. For this reason, the inter-group connection table 47 is represented as illustrated in an example of a table T2 in FIG. 18. In addition, in the example of the table T2 in FIG. 18, a circle mark illustrates a combination of a group in which communication is performed and an x mark illustrates a combination of the group in which the communication is not performed.

Next, the connection processing unit 35 calculates the number of VNFs 60 to be accommodated in a case where a subnetwork is set in each of combinations of groups in which the communication is performed by using information of the table T1. For example, a VNF 60 in the FW-G1 and a VNF 60 in the Cache-G1 are included in a subnetwork through which the VNF 60 in the FW-G1 and the VNF 60 in the Cache-G1 communicate with each other. For this reason, the connection processing unit 35 calculates that 1,000 VNFs 60 (500+500=1,000 units) that are the sum of the total number of VNFs 60 in the FW-G1 and the total number of VNFs 60 in the Cache-G1 are included in the subnetwork that is used in communication between the FW-G1 and the Cache-G1. The table T2 of FIG. 18 illustrates the calculated result of the connection processing unit 35 according to each combination of a group in which communication is performed. The same calculation is performed on a subnetwork that is used in communication between other groups. For example, the connection processing unit 35 calculates that 700 VNFs 60 (500+200=700 units) that are the sum of the total number of VNFs 60 in the FW-G1 and the total number of VNFs 60 in the Cache-G2 are included in a subnetwork that is used in communication between the FW-G1 and the Cache-G2. In addition, the number of the VNFs included in a subnetwork that is used in communication between the FW-G2 and the Cache-G1, is 1,000 (500+500=1,000 units) that is the sum of the total number of VNFs 60 in the FW-G2 and the total number of VNFs 60 in the Cache-G1. Since the total number of VNFs 60 in groups of the FW-G2 and the Cache-G2 is included in a subnetwork that is used in communication between the FW-G2 and the Cache-G2, 700 VNFs 60 (500+200=700 units) are included in the subnetwork. Since the total number of VNFs 60 of the FW-G2 and the WOC-G1 is included in a subnetwork that is used in communication between the FW-G2 and the WOC-G1, 800 VNFs 60 (500+300=800 units) are included in the subnetwork. 300 VNFs 60 (200+100=300 units) are included in a subnetwork that is used in communication between the Cache-G2 and the minority-G1. 400 VNFs 60 (300+100=400 units) are included in a subnetwork that is used in communication between the WOC-G1 and the minority-G1.

Next, the connection processing unit 35 determines to connect communication by using a router 7 when the number of VNFs 60 to be accommodated is smaller than a predetermined value in a case where a subnetwork is set. For example, when the predetermined value is 500, the connection processing unit 35 determines to communicate through the router 7 without using a subnetwork in communication between the Cache-G2 and the minority-G1, and communication between the WOC-G1 and the minority-G1. Then, the connection processing unit 35 determines a subnetwork that is set between groups that perform communication between groups by using the subnetwork, and determines a network address. These pieces of information are recorded in the inter-group connection table 47 similar to the first embodiment.

Then, the connection processing unit 35 performs the same processing as the processing, which is described with reference to FIG. 13 to FIG. 15 in the first embodiment, on the groups that communicate using the subnetwork.

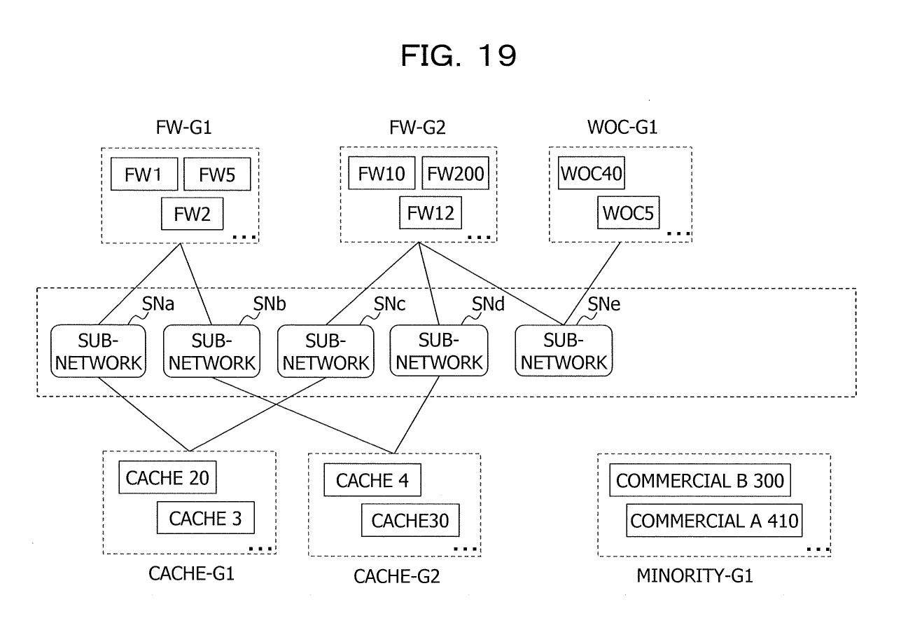

FIG. 19 is a diagram illustrating an example of the connection processing performed in the second embodiment. FIG. 19 illustrates a state where subnetworks SNa to SNe are set by performing processing on a subnetwork that is not a target connected by using a router. A path is not yet set which is used for communicating a VNF 60 in the minority-G1 that is not connected to the subnetwork with a VNF 60 in another group when a setting is terminated to the subnetworks SNa to SNe.

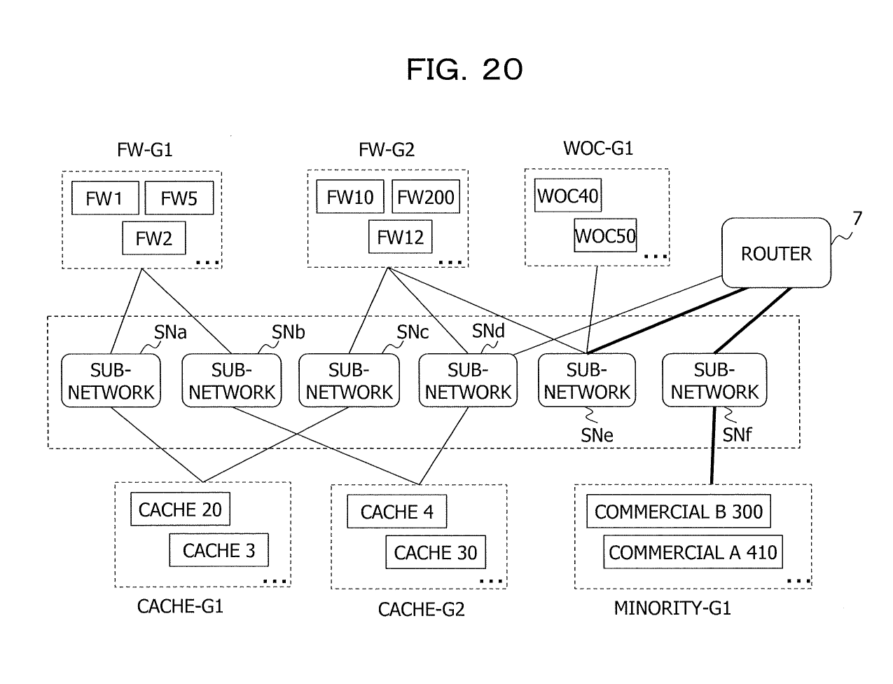

FIG. 20 is a diagram illustrating an example of a network obtained in the second embodiment. Subnetworks as illustrated in FIG. 19 are set, then the connection processing unit 35 sets a VNF 60 included in the minority-G1 in a subnetwork SNf for connecting with a router 7. In addition, the connection processing unit 35 notifies each of the VNFs 60, which are included in the minority-G1, of an IP address that is used in communication in the subnetwork SNf, and assigns the IP address that is used in the communication in the subnetwork SNf to the router 7.

Next, the connection processing unit 35 specifies a subnetwork to which a group where the minority-G1 performs communication through the router 7 is connected. As illustrated in the table T2 of FIG. 18, a group included in a VNF 60 in which a VNF 60 in the minority-G1 communicates through the router 7 is the Cache-G2 and the WOC-G1. Furthermore, the connection processing unit 35 specifies that the Cache-G2 is connected to the subnetworks SNb and SNd, and the number of VNFs 60 that are included in these subnetworks. Since any one of the subnetwork SNb and the subnetwork SNd includes 700 VNFs 60, each subnetwork can not include only VNFs 60 of a smaller number than an upper limit (1000 units) of the number of VNFs 60 in the subnetwork. Therefore, the connection processing unit 35 determines to include the router 7 in any one of the subnetworks SNb and SNd, and performs address setting for the router 7. A case where the router 7 is included in the subnetwork SNd is illustrated as an example in FIG. 20.

Since the same processing on the WOC-G1 is performed, the connection processing unit 35 specifies that the WOC-G1 is connected to the subnetwork SNe. The connection processing unit 35 compares the total number (800 units) of VNFs 60 included in the subnetwork SNe with the upper limit (1000 units) of the number of the VNFs 60 in the subnetwork. Since the total number (800 units) of VNFs 60 included in the subnetwork SNe is lower than an upper limit of the number of VNFs 60 in the subnetwork, the connection processing unit 35 determines that the router 7 is also included in the subnetwork SNe, and performs address setting for the router 7. Then, as illustrated in FIG. 20, a path between the subnetwork SNd and the router 7, and a path between the subnetwork SNe and the router 7 are generated.

Next, a method of determining an address which the connection processing unit 35 notifies as a destination address in a VNF 60 included in a service chain that performs communication through a router will be described. The connection processing unit 35 sets an address of a transfer destination to an address of a router 7 when a subnetwork is not set between a VNF 60 in a service chain and a transfer destination of the VNF 60. Meanwhile, the connection processing unit 35 requests a setting change of the routing table 61 by the same processing as the first embodiment with respect to a VNF 60 of a transfer destination of a packet and a VNF 60 that is connected through a subnetwork. According to these processing methods, it is possible for a VNF 60 in the minority-G1 to communicate with a VNF 60 of the transfer destination.

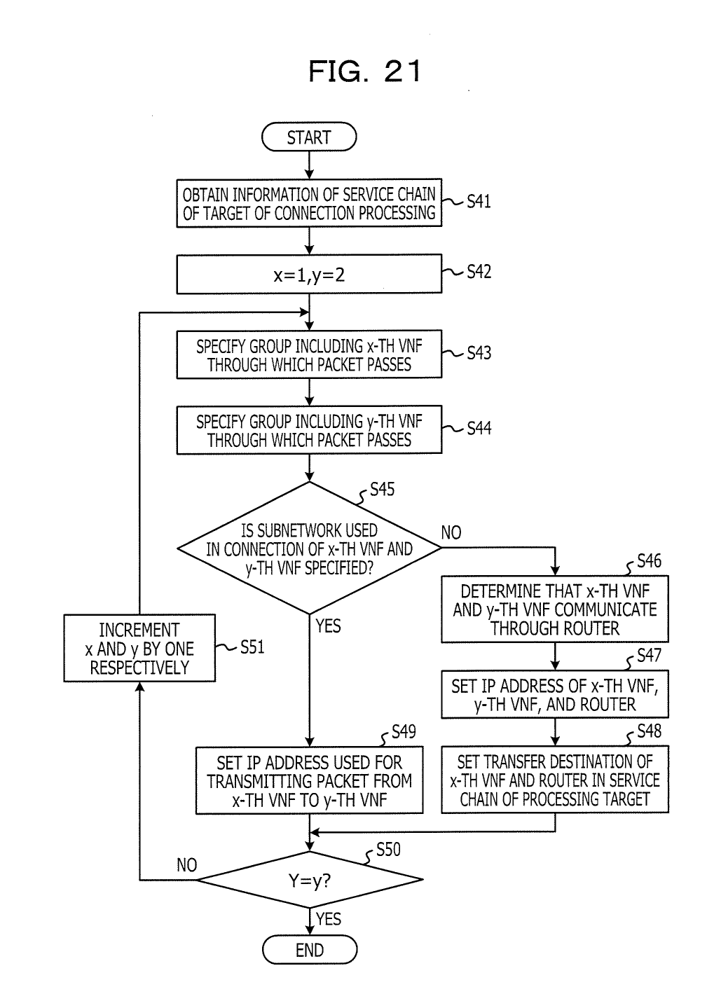

FIG. 21 is a flow chart illustrating an example of the connection processing performed in the second embodiment. Processing of steps S41 to S44 is the same as steps S31 to S34 described with reference to FIG. 15. Next, the connection processing unit 35 determines whether or not a subnetwork used in connection of an x-th VNF 60 and a y-th VNF 60 in a service chain of a processing target can be specified by using the inter-group connection table 47 (step S45). When the connection processing unit 35 can specify the subnetwork used in connection of the x-th VNF 60 and the y-th VNF 60 in the service chain (Yes in step S45), the connection processing unit 35 sets information such as an IP address that is used for transferring a packet for the x-th VNF 60 and the y-th VNF 60 (step S49).

Meanwhile, when the connection processing unit 35 can not specify the subnetwork used in connection of the x-th VNF 60 and the y-th VNF 60 in the service chain (No in step S45), the connection processing unit 35 determines that the x-th VNF 60 and the y-th VNF 60 communicate with each other through the router 7 (step S46). The connection processing unit 35 sets an IP address of the x-th VNF 60, the y-th VNF 60, and the router 7 (step S47). Furthermore, the connection processing unit 35 sets a transfer destination of the x-th VNF 60 and the router 7 in a service chain of a processing target (step S48).

When processing of step S48 or step S49 is terminated, the connection processing unit 35 compares the variable y with the integer Y (step S50). When the variable y is less than the integer Y, the connection processing unit 35 increments the variable x and the variable y by one, respectively, and repeats step S43 and subsequent processing (No in step S50, and step S51). When the variable y is equal to or greater than the integer Y, the connection processing unit 35 determines that a setting of the entirety of VNFs 60 included in the service chain is terminated, and terminates processing (Yes in step S50).

According to the above, it is possible to perform communication between VNFs 60 that are classified into each group while decreasing the number of subnetworks set in a network. Accordingly, it is possible to include VNFs 60 with numbers greater than the first embodiment in a communication system.

In addition, embodiments are not limited to the above, and there are various possible modifications. Such examples will be described in the following.

For example, when a new service chain is set, the entirety of VNFs 60 included in a service chain that is newly generated may be set to communicate through one specific subnetwork. In this case, it is possible to further suppress change of a communication environment in a subnetwork through which the new service chain does not pass according to an increase of the new service chain.

The tables illustrated in the above description are only examples, information elements or formats in each table can be changed according to implementations.

In the above description, a case where processing is performed by using a VLAN as an example is described. However, it is preferable to control a subnetwork using other techniques such as Virtual eXtensible Local Area Network (VXLAN). Furthermore, a management target of the management apparatus may be a communication device that is not the virtual machine, and a communication device that communicates using VLAN and IP techniques.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network management apparatus comprising:
a memory; and
a processor coupled to the memory and configured to:
classify a plurality of communication devices in a network into a plurality of groups based on each combination of each type of packet processing performed in each of the plurality of communication devices and each type of packet processing performed in each transfer destination of each of the plurality of communication devices,
set at least one virtual subnetwork so that a virtual subnetwork, which couples to at least one first communication device in a first group of the plurality of groups and at least one second communication device in a second group of the plurality of groups, is set when the at least one first communication device transfers a packet to the at least one second communication device, and
transmit a control packet for communications via the virtual subnetwork, to the at least one first communication device and the at least one second communication device.

2. The network management apparatus according to claim 1,
a virtual subnetwork, which couples to the at least one first communication device and at least one third communication device in a third group of the plurality of groups, is not set when the at least one first communication device does not transfer a packet to the at least one third communication device.

3. The network management apparatus according to claim 1,
the processor is configured to determine that the at least one first communication device transfers a packet to the at least one second communication device when a first type of packet processing performed in each transfer destination of the at least one first communication device is same as a second type of packet processing performed in the at least one second communication device.

4. The network management apparatus according to claim 1, wherein
when N, which is the number of the plurality of communication devices whose types of packet processing are same, is equal to or more than predetermined number, the processor is configured to classify the N of the plurality of communication devices into a fourth group and a fifth group of the plurality of groups, and
a virtual subnetwork, which couples to at least one fourth communication device in the fourth group and at least one fifth communication device in the fifth group, is not set.

5. The network management apparatus according to claim 2, wherein
the network includes a router, and
the processor is configured to:
determine a total number of the at least one third communication device and at least one sixth communication device that is each transfer destination of the at least one third communication device,
set a virtual subnetwork coupling to the at least one third communication device and the router, and
transmit a request packet for requesting the at least one third communication device to transfer a packet to the at least one sixth communication device via the router.

6. A network management method comprising:
classifying a plurality of communication devices in a network into a plurality of groups based on each combination of each type of packet processing performed in each of the plurality of communication devices and each type of packet processing performed in each transfer destination of each of the plurality of communication devices;
setting at least one virtual subnetwork so that a virtual subnetwork, which couples to at least one first communication device in a first group of the plurality of groups and at least one second communication device in a second group of the plurality of groups, is set when the at least one first communication device transfers a packet to the at least one second communication device; and
transmitting a control packet for communications via the virtual subnetwork, to the at least one first communication device and the at least one second communication device.
